(19) United States
(12) Patent Application Publication
(10) Pub. No.: US 2007/0277100 A1
(43) Pub. Date: Nov. 29, 2007

(54) Method and system for a user input solution for a limited telecommunication device

(75) Inventors: Michael A. Sheha, Laguna Niguel, CA (US); Angie Sheha, Laguna Niguel, CA (US); Brian Urioste, Corona, CA (US)

Correspondence Address: MORRISON & FOERSTER, LLP, 555 WEST FIFTH STREET, SUITE 3500, LOS ANGELES, CA, 90013-1024, US

(73) Assignee: NETWORKS IN MOTION, INC., Irvine, CA (US)

(21) Appl. No.: 11/635,917

(22) Filed: Dec. 7, 2006

Related U.S. Application Data
(60) Provisional application No. 60/748,463, filed on Dec. 7, 2005.

(51) Int. Cl. G06F 15/00; G06F 3/00

(52) U.S. Cl. 715/531; 715/700

(57) ABSTRACT

It is an object of the present invention to provide a method and system for enabling a simple and efficient method of directional arrows for the purpose of easily maneuvering throughout a contextual menu system (i.e., menus, text entry boxes, buttons, and the like) on a mobile device using limited input keys. In one embodiment, this allows a user to only require a rocker key with “directional arrows” and a select key, which is sometimes referred to as an “OK” or “Enter” key, to fully maneuver a menu and text entry system on a mobile device. This includes going forwards and backwards in the menu system tree, in addition to moving upwards and downwards in any menu list, all without needing to use any other keys. In another embodiment, this solution enables and illustrates a plurality of a-priori defined graphical pathways for the user to navigate.

### CROSS-REFERENCE TO RELATED APPLICATIONS

The present invention claims benefit under 35 U.S.C. 119(e) of U.S. Provisional Application No. 60/748,463 filed on Dec. 7, 2005, the contents of which are incorporated by reference herein.

### BACKGROUND

1. Field of Invention

This present invention relates to a method and system for maneuvering throughout a mobile device in combination with a enabling a text predictive solution that compliments each other in a novel approach.

### SUMMARY OF THE INVENTION

It is an object of the present invention to provide a method and system for enabling a simple and efficient method of directional arrows for the purpose of easily maneuvering throughout a contextual menu system (i.e., menus, text entry boxes, buttons, and the like) on a mobile device using limited input keys. In one embodiment, this allows a user to only require a rocker key with “directional arrows” and a select key, which is sometimes referred to as an “OK” or “Enter” key, to fully maneuver a menu and text entry system on a mobile device. This includes going forwards and backwards in the menu system tree, in addition to moving upwards and downwards in any menu list, all without needing to use any other keys. In another embodiment, this solution enables and illustrates a plurality of a-priori defined graphical pathways for the user to navigate.

It is an object of the present invention to provide a method and system to enable the directional arrows to convey different actions with different visual representations, such as colors, sizes, highlights, strokes, or the like. In one embodiment, since the left rocker key can have different functionality in the same screen based on the cursor's current position, such as when a cursor is in a text box and pressing the left rocker key can either move back one character in the string or go back to the previous screen if the cursor is at the beginning of the text box, a method is needed to differentiate to the user when each of these actions are is allowed while using a limited input solution as only a rocker key to move through and within screens.

It is an object of the present invention to provide a method and system for optimizing the viewable space on a navigation-enabled mobile device, such that the same window or screen can provide a plurality of views relating to similar information which can further be illustrated in a more appropriate manner from different viewpoints without causing confusion to the user. Additionally, this “look ahead” and “curtain” view allows a user to visualize a navigational display of the same turn using both a Limited Cartography (“LC”) displays and a Vector Map display. In one embodiment, a user can toggle between these views using the rocker keys on a mobile device that acts in the same manner as a window that slides between two views. This allows more content specific information to be visualized by the user that is pertinent to the particular view while having a common reference point, such as the current driving directions maneuver displayed to the user at all times. For example the user can toggle between the LC view and the vector map view of the same maneuver, while keeping the “next turn” name constant.

It is an object of the present invention for the “look ahead” and “curtain” view to be controlled either by the application, the user, or both. In one embodiment, a Limited Cartography (“LC”) displays will transition to a Vector Map display automatically based on the mobile device's GPS information as it approaches the current turn. In another embodiment, the user might be close enough to the turn such the application transitions to the Vector Map display, but the user wants to view the approaching turn using the Limited Cartography display. In this embodiment, the user always has the choice to change the view manually. In this same embodiment, the application will transition to the Vector Map display based on the distance to the turn.

It is an object of the present invention to provide a method and system for predictive text to be generated, which is based on a database of validated spatial information, such as address information. In one embodiment, this validated spatial database of information is transferred to the device over a wireless connection, such as a GSM, UMTS, W-CDMA, CDMA, WiFi, Bluetooth, or the like.

It is an object of the present invention for the databases to be generated by a server system and transferred to the phone after the data has been validated. In one embodiment, the address information is constructed and validated on the server and transferred to the handset thus ensuring that the consistency of the data is preserved and accurate based on a database. In this embodiment, the database would be a spatial database that references address and mapping information.

It is another object of the present invention for the local mobile database to be adaptive and to be modified continuously during user entries, search experiences, and application interaction. In one embodiment, while a user searches for nearby local places, the system would learn the address information for each point of interest (POI) and continuously update the look ahead spatial cache (i.e., street address, city, state, zip code, and the like) to be indicative of the user's search patterns within the application. In another embodiment, every stored location, name, phone number, or the like that was qualified and sent to the mobile device from a server can be used in the text predictive solution. The application thus learns the user's “preferred” entries, such as a street address (i.e., their home address), or the yellow page name of “Mario's by the Sea”, or the zip code of the town the user is currently located in which is based on their GPS information, or the like. This allows the local database to organically grow based on the user's search patterns in connection with the server to include what is important to the user. In this same embodiment, as people skilled in the art will appreciate, this mitigates the need for the server to continuously send false positives to the mobile device, such as in the case when searching for “Pizza Hut” by entering just “Pi” in a search field input box for performing a “Local Search”. If the user just once views, maps, navigates to, or calls “Pizza Hut”, then the application will learn and store the name, phone number, and spatial information about “Pizza Hut”. In this same embodiment, the user will only need to enter “Pi” and the application will display to the user possible matches based on “Pi”, such as “Pizza Hut” without the need to interact with the server, since this information was already stored in the mobile device's database due to a previous search about this point of interest. The user effectively “pre-validates” the search term that is sent to the server for searching for the nearest “Pizza Hut” in the area, thus maximizing the ability of that first search to produce results that are relevant to what the user is searching for, such as finding a “Pizza Hut” near me based on my GPS information.

It is another object of the present invention for the database records to have spatial information, such as addresses, to include a timestamp of the last time the spatial data was requested to be added to the database.

It is another object of the present invention for the server system to validate spatial information, such as address information, for the purpose of only adding said spatial information to the mobile devices' database. This ensures a level of quality over non-validated information. Addresses are also added from a-priori defined lists which are downloaded from the server, such as state lists, airports, or the like. In one embodiment, the name and address information for “Starbucks, 35 Tesla, Irvine, Calif.” would only be added to the database if it was first validated and sent from the server to the mobile device. This ensures only qualified content can be stored in the local mobile device's database that is qualified by the server.

It is another object of the present invention to allow the text predictive algorithm to be based on a plurality of databases, such as both LRU (recent searches) and a standard persistent store with explicit additions and deletions, such as a user's personal favorites. Each database can have its own maximum size. Additionally, databases can be based on pre-defined databases that are immutable and defined by the server, such as state lists, airports, or the like.

It is another object of the present invention to store spatial information based on actions that the user does within the application for raking the results, all of which the provided results were sent from a server to a mobile device. In one embodiment, any and all spatial or non-spatial information that is sent from the server can be stored in the local database on the mobile device for the text predictive invention. In another embodiment, any item, including place address and phone numbers, that the user performs and action on, including viewing the address, mapped, navigated to (in a navigation device), calling a place (from the mobile device), saving as a favorite, or the like using an application specific action (i.e., which can vary per application) will be applied to the local database for the text predictive solution to utilize.

It is another object of the present invention to allow the database to be reset through the graphical user interface. In one embodiment, this includes deleting your favorites, clearing all the databases, or the like.

It is another object of the present invention for each field in the record and dataset to be searched against. This includes all spatial information fields, such as, but not limited to, the street address, city, state, and zip code.

It is yet another object of the present current invention for text predictive matches to be “string starts with” matches that are based on a string of characters which are entered by the user.

It is yet another object of the present invention for matches to be searched for based on key entries, such as entering a “T” in the state field matches “Tennessee”, while entering “TX” matches “Texas”.

It is yet another object of the present invention for the first result match to cause the un-entered text to be displayed in another color followed by a symbolic indicator, such as, in this embodiment, a right arrow. In one embodiment, depressing the right key from the key indicator commits the suggested text to the user's entered text. In another embodiment, selecting the “next match” key, which can be arbitrarily defined on the mobile device, results in the next match to be displayed instead of the first match.

It is yet another object of the present invention for the match order to be based on name or timestamp.

### BRIEF DESCRIPTION OF THE DRAWINGS

FIG. 1 illustrates a network system for providing a communication channel between various wireless and landline computing devices;

FIG. 2 illustrates one embodiment of the present invention showing a personal computer with an integrated web browser;

FIG. 3 illustrates one embodiment of the present invention of a wireless Telecommunication Device and an accompanying high-level block diagram of a wireless Telecommunication Device;

FIG. 4 illustrates one embodiment of a mobile device's limited user interface;

FIG. 5 illustrates one embodiment of a plurality of directional arrows and text predictive menu boxes;

FIG. 6 illustrates one embodiment for illustrating the limited cartography navigation screen on a limited screen size mobile device;

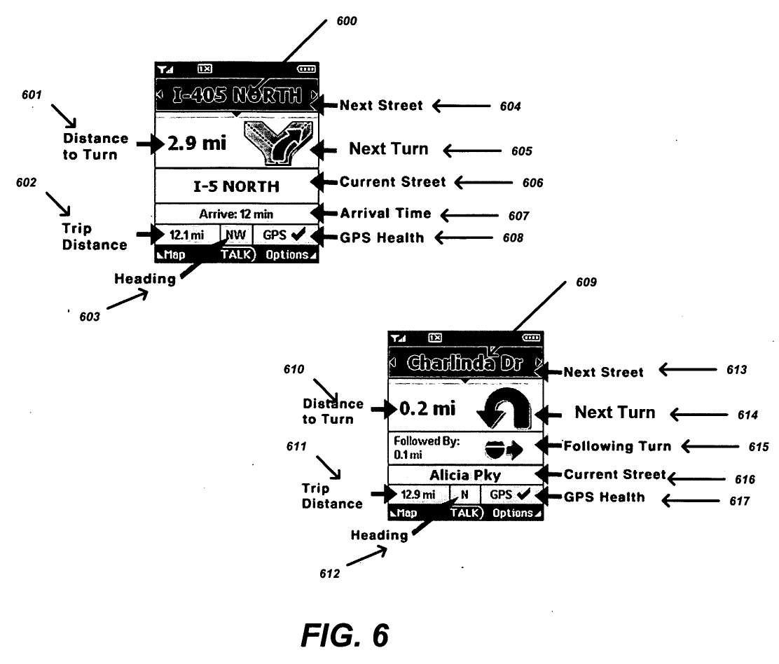

FIG. 7 illustrates one embodiment for illustrating the navigation look ahead/curtain view;

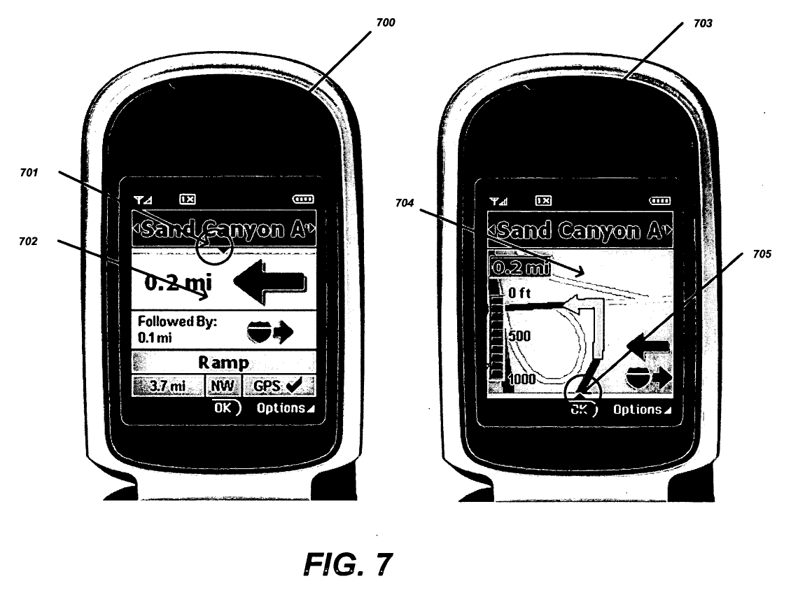

FIG. 8 illustrates yet another embodiment of the navigation look ahead screen;

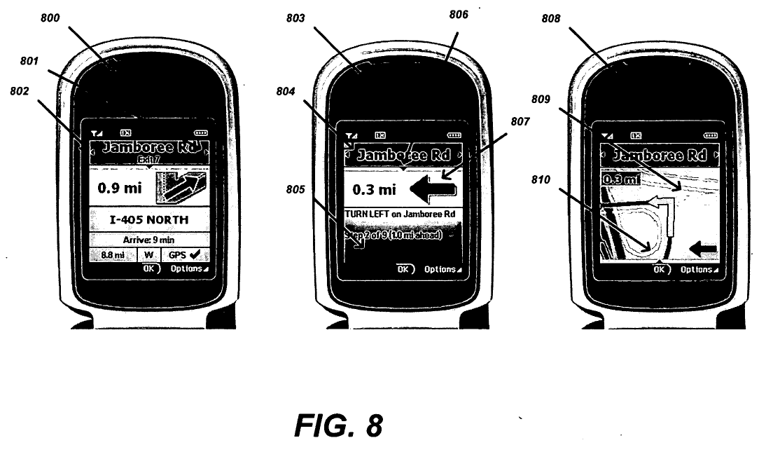

### DETAILED DESCRIPTION OF THE PREFERRED EMBODIMENTS

The preferred embodiments of the present invention relate to methods and systems for increasing the usability and functionality of the mobile device based on a limited user interface.

The present invention may be embodied in a pre-commercial (non-public) application called “AtlasBook” or “VZ Navigator” which is owned and licensed by Networks In Motion, Inc. of Irvine, Calif. “VZ Navigator” is a trademark of Verizon Wireless. These applications are connected to NIM's NAVBuilder server LBS platform.

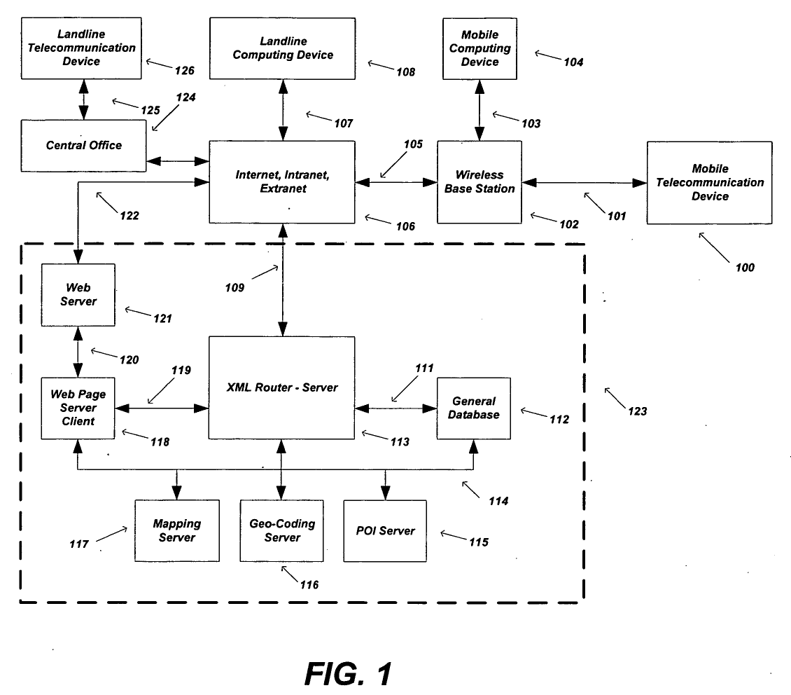

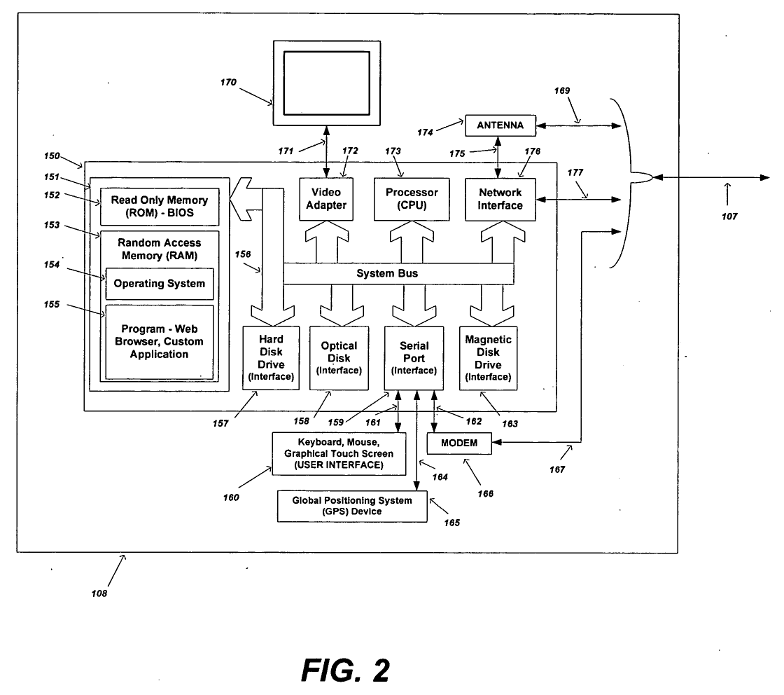

FIG. 1 and FIG. 2 illustrate high-level diagrams of one embodiment that is a suitable computing and networking environment in which the invention may be implemented. The invention will be described in the general context of an application that executes on an operating system in conjunction with a personal computer or server, but those skilled in the art will realize that this invention may also be implemented in combination with other program modules. Program modules typically include routines, programs, data structures, etc. that perform particular tasks or implement particular abstract data types. This invention is not limited to a typical personal computer, but may also be utilized with other computing systems, such as handheld devices, mobile lap top computers, wireless phones, in-vehicle navigation systems, programmable consumer electronics, mainframe computers, distributed computer systems, etc., and the like.

FIG. 1 is a network block diagram illustrating the connection (125 & 101) of both wireless 100 and wired 126 Telecommunication devices to an Application Service Provider (ASP) 123, also referred to as an online server system. This online server system may be configured at a single location and on a single computer, or can be configured as a distributed computer system and at different locations. The wireless Mobile Telecommunication Devices 100 are wirelessly connected 101 (i.e., CDMA, GSM, WiFi, Bluetooth, or the like) to a nearby wireless base station 102, which are typically connected or have access to 105 the Internet, Intranet, or Extranet 106. Additionally, a landline Telecommunication Device 126 is typically connected to a nearby central office 124 which is connected or has access to 123 the Internet, Intranet, or Extranet 106. Additionally, the Application Service Provider (ASP) 123 also has access 109 to the Internet, Intranet, or Extranet 106. The ASP 123 generally consists of a front-end firewall and XML router 113 which itself has access (111 & 114 & 119) to other local computing modules, such as a database 112, POI server 115, geocoding server 116, mapping server 117, and webpage client server 118. The web-server front-end 118 can be connected to the outside Internet, Intranet, or Extranet 106 either through the local front-end firewall 113, or as in this embodiment, via 120 the web server 121, which is connected 122 directly to the Internet, Intranet, or Extranet 106 by using a software firewall which is well known to those skilled in the art. Additionally, either mobile 104 or landline 108 computing devices, such as a personal computer, are connected to the Internet, Intranet, or Extranet 106, either directly 107 or through a wireless connection 103 and base station 102.

FIG. 2 illustrates a typical personal computer 150, that includes a central processing unit (CPU) 173, video adapter 172, hard disk drive 157, optical disk 158, serial port 159, magnetic disk drive 163, system bus 156, and network interface 176→177 & 167 & 169→109. The hard disk drive 157 typically refers to a local non-volatile storage system for storing large amounts of data, such as a web browser program files or cookies or a user's Contact data. The optical disk 158 typically refers to a CD-ROM disk used for storing read-only data, such as an installation program. The serial port interface 159 is typically used to connect 161 the computer 150 to external devices 160, such as a keyboard, mouse, and graphical touch screen interface, and also can connect 164 to positioning devices 165, such as a GPS receiver. The keyboard and mouse 160, amongst other input devices 165, enable users to input information into the computer 150. The connection 161 & 164 cables can include a serial cable or universal serial bus (USB) cable. Other input devices, that are not shown, may include a joystick, scanner, camera, microphone, or the like. The magnetic disk drive 163 is typically used to store small amounts data, in comparison to a hard 157 or optical 158 disk drive, and typically lacks the data transfer rates of those other storage drives, but it enables both readable and writable capability. The hard disk drive 157, optical disk drive 158, serial port interface 159, and magnetic disk drive 163 are all connected to the main system bus 156 of the computer 150 for transferring data. A monitor 170 or other type of display device, such as a LCD display, is connected 171 to the computer system's 150 video adapter 172, which is connected to the system bus 156. Additional peripheral output devices, which are not included in this embodiment, such as a printer, speaker, etc., can also be connected to a personal computer 150. The system bus 156 also connects to the network interface 176, central processing unit (CPU) 173, and system memory 151. The system memory 151 contains both random access memory (RAM) 153, and read only memory (ROM) 152, that typically consists of the BIOS (Basic Input/Output System) of the computer, necessary for containing basic routines that enable the transfer of information between elements within the personal computer 150. The RAM 153 stores a number of program modules, such as the web browser and synchronization applications 155, and the Operating System 154 of the personal computing device 150 or personal computer 150. One example of such a program module 155 would be a web browser that is connected to the “NAVBuilder” server that was previously mentioned.

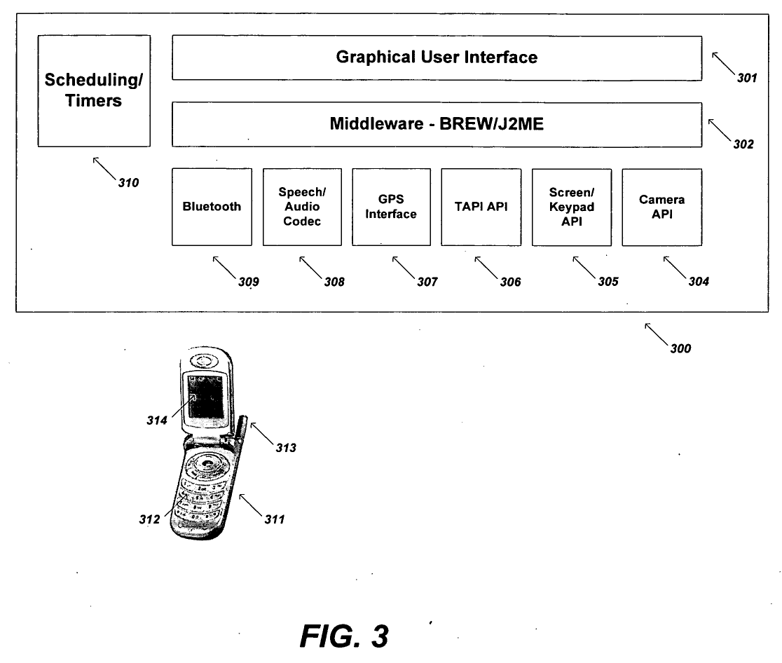

FIG. 3 illustrates a next generation wireless Telecommunication Device 311 which typically includes a display 314, an antenna 313, and a keypad 312. The next generation wireless Telecommunication Device 311 & 300, as illustrated in FIG. 3, provides a foundation 302 for running programs or applications that can access the Telecommunication Device's 311 internal interfaces, such as the Bluetooth 309, Speech/Audio Codec 308, GPS Interface 307, TAPI (Telephony Application Program Interface) 306 Interface, Screen/Keypad API (Application Program Interface) or Interface 305, Camera API 304, or the like as well known to those that are skilled in the art. As those that are skilled in the art will appreciate, a Telecommunication Device (300 & 311) will also include scheduling/timers 310 for scheduling specific events as is provided with standard computing platforms. Additionally, next generation Telecommunication Devices (300 & 311) have graphical user interfaces (GUI) 301 for applications to allow user input using a graphical display 314. As people skilled in the art will appreciate, these next generation Telecommunication Devices provide the means to access the Telecommunication Devices' internal APIs using a middleware 302 platform, such as BREW, J2ME, Symbian, Linux, which are well known to those skilled in the art. This simplifies the development process since there is significant support for obtaining developer access to the Telecommunication Device's internal APIs, such as the TAPI interface for making telephone calls and capturing call logs.

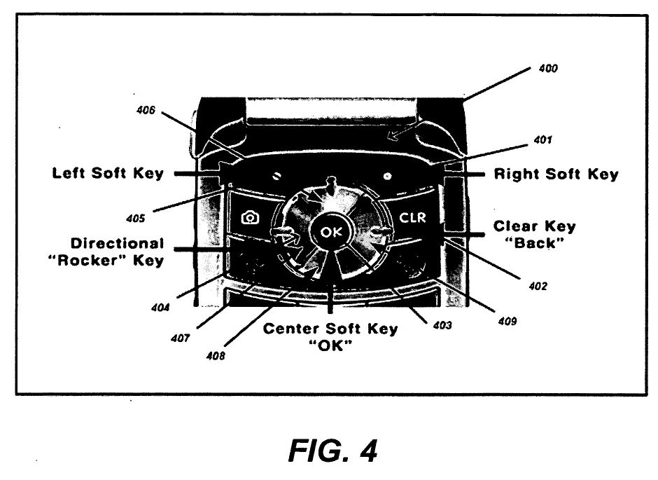

FIG. 4 illustrates a typical wireless device design 400 that includes a Right Soft Key 401 and Left Soft Key 405, which are hardware keys that relate to software controllable functions. Other keys include the directional Rocker Key 404 for trapping up/down/left/right key events, the Center Soft Key 403 or the “OK” key 403 which provides the select or enter functionality, and the Clear Key 402 which is used for going back in the user interface flow within an application and the handset's O/S. Those that are skilled in the art will realize that this is a typical layout for most mobile devices in various embodiments and markets.

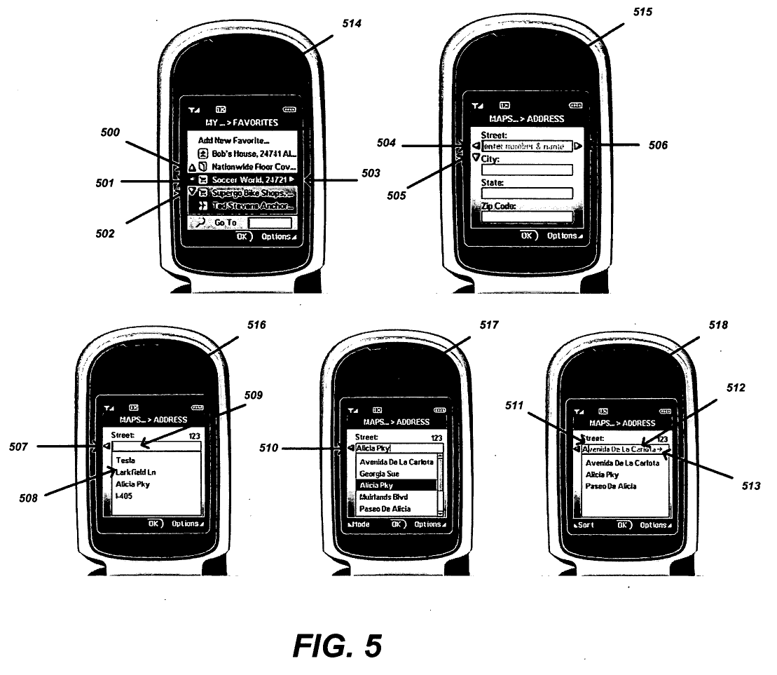

FIG. 5 illustrates the graphical method of moving effectively throughout an application user interface (UI) that also adds significant value in enabling a text predictive system. As people skilled in the art will appreciate, prior art menu layouts enable users to move only upwards and downwards in a menu list without a clear and graphical indication of the allowed options for moving within that menu structure, such as in one embodiment, going forward and backwards to the previous and next screen in a UI flow. People that are skilled in the art will appreciate that a new layout of graphical icons 500 501 502 503 which illustrate your movement throughout the menu structure greatly simplify the application usability. Additionally, it illustrates the available options that the user can move 515, such as only being able to move downwards 505, back to the previous menu 504, or forward to the next screen 506. As people that are skilled in the art will appreciate, typical advancing and retreating within a menu structure's various screens is done by using the device's “OK” 403 and “CLR” clear keys 402. This new method allows the advancing 503 and retreating 501 to also be simplified by both graphical icons and the use of the rocker keys 404, thus providing a more advanced flow throughout the application. It should be noted that the graphical icons are coupled directly with the rocker key icons, such as directional arrows up 500 down 502 left 501 and right 503 are directly tied to the up 406 down 408 left 404 and right 409 rocker keys. Toggling between two screens (i.e., the first 515 then the next 516) is simply enabled by the forward 506 and backwards 507 icons illustration between two different screen flows in combination with the right and left rocker key, respectively.

An extension of the graphical method for selecting a text cached solution 516 of street addresses 508 for a particular text entry box 509 is further enhanced by the use of graphical icons in combination with the rocker key. In one embodiment, the backwards graphical icon's 507 color is transitioned 510 when entering data into the text box, thus illustrating that the back functionality enacted by the left rocker key is not designed to go backwards, but rather to delete characters within the text entry box 509.

For the text predictive solution, the preferred embodiment 518 is based on learning the data of the application as the user uses the application through means of an online server database. This allows the application to learn the use patterns of the user through searching for addresses, points of interest which includes names, addresses, search patterns, or the like via the online server database through a wireless connection. In one embodiment, once the application has learned the desired material, entering the information again in the application can be facilitated by selecting a cached entry for quickly re-entering the data again. Typically data is stored in a cache as a First In-First Out cache (FIFO).

For example, in one embodiment, when a user searches for a local business, the application will store all of the data associated with a resulting place, such as but not limited to:

| Location | Value | Description |
|---|---|---|
| | area name | Area Name |
| | streetnum | Street Number |
| | street1 | Street One Field |
| | street2 | Street Two Filed (suite #, etc.) |
| | city | City Field |
| | county | Country Field |
| | state | State Field |
| | postal | Postal/Zip Code |
| | country | Country Field |
| | airportcode | Airport Code |
| | latitude | Latitude Value |
| | longitude | Longitude Value |
| | location type | Location Type |
| | Value | |
| Phone | Country Code | Phone Country Code |
| | Area Code | Phone Area Code (NPA) |
| | Number | Phone Number (NXX + 4 digits) |
| Category | Category Code | Location - Yellow Page Category Code |
| | Length | |
| | Category Name | Location - Yellow Page Category Name |
| Place | Name | Place Name |
| | Phone | Place Number |
| | Category | Place Category |

When future data entrees are made that match the previous searched data, then that data is provided to the user as an exact match, so that an additional request to the network is not needed to perform the search and find the information, thus allowing the user to select the exact information locally on the device. As it should be appreciated by those that are skilled in the art, people typically search for results that were previously entered, since humans are very repeatable by nature. For example, a person might search for the POI “Starbucks” repeatedly while on a business trip throughout various locations within a given geographical area. Only having to enter “St” will not improve their chances of success without selecting a category first, such as “Coffee Shops” as the server system has to do fuzzy searching on the input string. Entering “St” might return “St. Ann's College” since the server is matching local search data that could be within a certain proximity or area.

As people that are skilled in the art will appreciate, if a user searched for “Starbucks” in the past, then the text predictive solution will cache that information locally and offer it in a single text box solution 512 such that the user is able to pick from it without needing to scroll down to a list of choices. This is typically known in the art as “auto complete”. The search for “Starbucks” has been validated from the server already, and now (more importantly) the user initiating the search, since only validated searches are sent to the mobile device. This provides a level of quality, thus improving the search probability since the user qualifies the results before the search is sent to the server.

As people that are skilled in the art will appreciate, users typically don't like to enter lots of data on a mobile device through a key pad, since it takes significant effort, specifically with a “multi-tap” solution. Reducing that effort provides a significant enhancement in making sure that the search the user will do shall provide meaningful results, since the phrase “garbage in, garbage out” applies to this idea. This invention better qualifies the input search data, based on previous searches for known entries, such as local business names, address values (street, city, state, zip code), and the like without having to go back to the database on the server, thus reducing wireless network traffic and improving the scalability of the wireless network, server system, and the quality of the entry method.

Thus, any item that is searched for, viewed, mapped, navigated to, called, or the like will be applied to the local database.

As those skilled in the art will appreciate, below is the preferred example embodiment for the matching algorithm for text predictive solution:

| | |
|---|---|
| function GetMatches(prefix, addressPart): | where prefix is the |

user entered text and addressPart is an address field ID (city, state, etc.)

resultList = [ ]
databaseList = GetDatabases(addressPart)
foreach db in databaseList:

foreach record in db:

fieldText = GetFieldText(record, field)
prefixLength = StringLength(prefix)
if StringCompareN(prefix, fieldText, prefixLength) ==
true:

AppendResult(results, fieldText)

Sort(resultList, criteria)
return resultList

The navigation screen “look ahead” provides a unique method and system for displaying multiple views of the same information within the same display on a limited screen 314 for a mobile device 313. In one embodiment, a navigation display contains the next street 600, next turn 605, distance to turn 601, current street 606, trip distance 602, heading 603, arrival time 607, and GPS Health 608. When the mobile device approaches a turn that has a stacked maneuver (i.e., a turn that is followed immediately by another turn), then a different display is shown that conveys the same, but additional information of the stacked turn 615. In order to prioritize the information to the user, the top information that is provided is the next street 613, next turn 614, distance to turn 610, current street 616, trip distance 611, heading 612, and GPS Health 617.

It will be appreciated by those skilled in the art that the reason the arrival time 607 is not shown in the stacked turn 615 view is since stack turns are only visible when the user is near the stacked turn. Additionally, the user can always left toggle 802 (press left on the rocker key) from the navigation screen to view the trip summary information which contains the arrival time information, and then back to the navigation screen using the right toggle arrow 801.

As people that are skilled in the art will appreciate, this invention provides a method and system for illustrating a “limited cartographic” (LC) view 700 & 702, and a “turns map” view 703 & 704, without requiring the need to change the reference view of the next turn “Sand Canyon Avenue”. This is accomplished through the “curtain” approach 701 that will maintain the view of both representations (i.e., LC and vector) for the same maneuver, but with a different visualization that is important. After the user has toggled from the LC view 702 to the turns map view 704 using the top down “curtain” 701, the user is able to transition back to the LC view 702 from the turns map view 704 using the bottom up “curtain” 705 with just using the rocker's up 406 and down 408 keys respectively.

This invention also supports have the application automatically transition the view form LC to vector. In one embodiment, this could be triggered as the mobile device approaches the maneuver, or the like

Additionally, the “look ahead” functionality utilizes the ability for the user to manually look at new turns in the future using the right toggle 801 functionality and the respective rocker key. The future maneuvers 803 & 808 view(s) intentionally looks different than the current turns view 800, since it includes the text directions 805 for that turn, but keeps a similar look and feel around the current turn icon 807. Each future maneuver view 803 & 808 also includes the “curtain” approach of toggling between the limited cartography view screen 805 and the vector view screen 809 using the top down “curtain” 806 and the bottom up “curtain” 810.

As people that are skilled in the art will appreciate, this view reduces the user interface while maintain and maximizing the content for the navigation device within a limited screen device.

The following discusses preferred embodiments for creating a graphical LBS suite application for a mobile device with a limited user input and screen size. This LBS suite application includes all of the features described in this invention, including, but not limited to, the graphical user interface toggle solution and text predictive solution.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

It should be noted that the present invention may be embodied in forms other than the preferred embodiments described above without departing from the spirit or essential characteristics thereof. The specification contained herein provides sufficient disclosure for one skilled in the art to implement the various embodiments of the present invention, including the preferred embodiment, which should be considered in all aspect as illustrative and not restrictive; all changes or alternatives that fall within the meaning and range or equivalency of the claim are intended to be embraced within.

We claim:

1. A portable electronic device comprising:
a display;
a plurality of rocker keys each rocker key being associated with a spatial direction;
a processor and
a memory, the memory including a plurality of instructions for execution by the processor and configured to cause the processor to:
display a user interface at the display, the user interface having a present state;
associate one or more of the rocker keys with a particular user command that is available to the user at the present state of the user interface;
display a plurality of arrows in the user interface, each arrow being associated with a spatial direction associated with a user command that is available to the user at the present state of the user interface.

2. The device of claim 1, wherein the device is a mobile telephone.

3. The device of claim 2, wherein the memory further comprises a navigation application.

4. The device of claim 1, wherein each of the plurality of rocker keys include a visible arrow that signifies a direction that the rocker key is associated with.

5. The device of claim 4, wherein the displayed arrows are displayed in the user interface in positions that are configured to indicate to the user the associated user command.

6. The device of claim 5, wherein the user interface includes a highlighted area, the highlighted area indicating a present user selection, and the displayed arrows are displayed around the highlighted area.

7. The device of claim 6, wherein:
the user interface includes a multi level menu and a plurality of items displayed therein;
the highlighted area indicates a selected item of the several items;
a left arrow is associated with a user command to traverse backward in the multi level menu;
a right arrow is associated with a user command to traverse forward in the multi level menu based on the current selected item; and
an up arrow is associated with a user command to select a higher menu item within the several displayed menu items;
a down arrow is associated with a user command to select a lower menu item within the several displayed menu items.

8. A method for presenting information to a user by utilizing a portable electronic device that comprises a display and a plurality of rocker keys, each rocker key being associated with a spatial direction, the method comprising:
display a user interface, the user interface having a present state;
associate each of one or more of the rocker keys with a particular user command that is available to the user at the present state of the user interface;
display a plurality of arrows in the user interface, each arrow being associated with a spatial direction associated with a user command that is available to the user at the present state of the user interface.

9. The method of claim 8, wherein the device is a mobile telephone.

10. The method of claim 8, wherein each of the plurality of rocker keys includes a visible arrow that signifies a direction that the rocker key is associated with.

11. The method of claim 10, wherein the displayed arrows are displayed in the user interface in positions that are configured to indicate to the user the associated user command.

12. The method of claim 11, further comprising:
highlighting an area of the interface, the highlighted area indicating a present user selection; and
displaying arrows around the highlighted area.

13. The method of claim 12, further comprising:
displaying a plurality of items within a multi level menu at the user interface, wherein the highlighted area indicates a selected item of the several items
associating a left arrow key of the rocker keys with a user command to traverse backward in the multi level menu;
associating a right arrow key of the rocker keys with a user command to traverse forward in the multi level menu based on the current selected item;
associating a up arrow of the rocker keys with a user command to select a higher menu item within the several displayed menu items; and
associating a down arrow key of the rocker keys with a user command to select a lower menu item within the several displayed menu items.

14. The method of claim 8, further including the steps of:
associating two user commands with a single rocker key wherein no more than one user command is valid at any given state, one of the commands being valid in the present state;
associating a different color with each of the two user commands;
displaying the arrow associated with the given rocker key in a color associated with the command of the two commands that is valid in the present state.

15. A portable electronic device comprising a display, a key pad capable of entering letters, a processor and a device readable medium, the device readable medium comprising a plurality of instructions for execution by the processor and configured to cause the processor to:
receive an entry of a first text string defining a search item;
send the first text string to a remote server;
save the first text string at the portable electronic device;
receive an entry of a short sequence of letters;
display the short sequence of letters on the display;
perform a search in the portable electronic devices memory based on the short sequence of letters;
determine whether the short sequence of letters match the beginning letters of the first text string; and
upon a positive determination, automatically complete the short sequence of letters by displaying the rest of the first text string immediately after the short sequence of letters.

16. The device of claim 15, wherein the portable electronic device is a mobile telephone.

17. The device of claim 16, wherein the instructions are a part of a navigation application and the first text string is a location.

18. The device of claim 17, wherein the first text string is an address.

19. The device of claim 17, wherein the instructions further cause the processor to receive a verification that the first text string is valid from the remote server, wherein the first text string is saved at the portable electronic device only if said verification is received.

20. A portable electronic device comprising:
a display;
a keypad configured to allow the entry of letters;
a processor and
a memory, the memory including a plurality of instructions for execution by the processor and configured to cause the processor to:
allow the user to enter a first text string defining a search item;
send the first text string to a remote server;
save the first text string at the portable electronic device;
allow the user to enter a short sequence of letters;
display the short sequence of letters on the display;
perform a search in the portable electronic devices memory based on the short sequence of letters;
determine that the short sequence of letters matches the beginning letters of the first text string; and
automatically complete the short sequence of letters by displaying the rest of the first text string immediately after the short sequence of letters.

21. The device of claim 20, wherein device is a mobile telephone.

22. The device of claim 21, wherein the first text string is an address.

23. The device of claim 21, wherein the instructions further cause the processor to receive a verification that the first text string is valid from the remote server, and wherein the first text string is saved at the portable electronic device only if said verification is received.

24. A portable electronic device comprising a display, a plurality of rocker keys including at least an up and a down key, a processor and a device readable medium, the device readable medium comprising a plurality of instructions for execution by the processor and configured to cause the processor to:
display a first information set at the display;
display an indication that a second information set is available;
receive a command from the user; and
display the second information set, by progressively sliding the second information set across the display so that it appear that the second information set is dragged over the first information set,
wherein the first and second information sets are related.

25. The device of claim 24, wherein the sliding of the second information set is displayed in such a way as to remind the user of the user of the sliding of a vertical window blind over window.

26. The device of claim 24, wherein the command received from the user is a press of the up or down rocker key, and the sliding of the second information set is performed by sliding the second information set vertically over the first.

27. The device of claim 26, wherein the direction in which the second information set is slid is the same as the direction associated with the pressed rocker key.

28. The device of claim 27, wherein the indication that a second information set is available includes an arrow which is in the same direction as the rocker key which is to be pressed to bring up the second set of information.

29. The device of claim 28, wherein the instructions are configured to further cause the processor to:
display a second indication that the second information can be removed;
receive a second command;
display the first information set, by progressively sliding the first information set into view as to appear the second information set is being slid away from the first information set in order to reveal the first information set from under the second information set.

30. The device of claim 24, wherein the instructions are part of a navigation application executing at the portable device, and the first and second sets of information sets comprise driving directions.

31. The device of claim 30, wherein the second information set comprises driving directions that are to be performed after the driving directions comprised in the first information set are performed.

32. A portable electronic device comprising:
a display;
a plurality of rocker keys each rocker key being associated with a spatial direction, the plurality of rocker keys including at least an up and a down key;
a processor and
a memory, the memory including a plurality of instructions for execution by the processor and configured to cause the processor to:
display a first information set at the display;
display an indication that a second information set is available;
receive a command from the user; and
display the second information set, by progressively sliding the second information set across the display so that it appears that the second information set is dragged over the first information set,
wherein the first and second information sets are related.

33. The device of claim 32, wherein the sliding of the second information set is displayed in such a way as to remind the user of the user of the sliding of a window blind.

34. The device of claim 32, wherein the command received from the user is a press of the up or down rocker key, and the sliding of the second information set is performed by sliding the second information set vertically over the first.

35. The device of claim 34, wherein the direction in which the second information set is slid is the same as the direction associated with the pressed rocker key.

36. The device of claim 35, wherein the indication that a second information set is available includes an arrow that is in the same direction as the rocker key which is to be pressed to bring up the second set of information.

37. The device of claim 36, wherein the memory further comprises instructions which cause the processor to:
display a second indication that the second information can be removed;
receive a second command;
display the first information set, by progressively sliding the first information set into view as to appear the second information set is being slid away from the first information set in order to reveal the first information set from under the second information set.

38. The device of claim 32, wherein the instructions are part of a navigation application executing at the portable device, and the first and second sets of information sets comprise driving directions.

39. The device of claim 38, wherein the second information set comprises driving directions that are to be performed after the driving directions comprised in the first information set are performed.
